(19) United States
(12) Patent Application Publication
(10) Pub. No.: US 2002/0103395 A1
(43) Pub. Date: Aug. 1, 2002

(54) Method of producing bis (cyclopentadienyl) ruthenium derivative, bis (cyclopentadienyl) ruthenium derivative produced by the same method, and method of producing thin film of ruthenium or ruthenium compound

(75) Inventor: Masayuki Saito, Kanagawa (JP)

Correspondence Address: ARENT FOX KINTNER PLOTKIN & KAHN, PLLC, Suite 600, 1050 Connecticut Avenue, N.W., Washington, DC, 20036-5339, US

(73) Assignee: Tanaka Kikinzoku Kogyo K.K.

(21) Appl. No.: 09/986,312

(22) Filed: Nov. 8, 2001

(30) Foreign Application Priority Data
Jan. 29, 2001 (JP) 2001-019937

(51) Int. Cl. C07F 17/02

(52) U.S. Cl. 556/136

(57) ABSTRACT

There is provided a method of producing a bis(cyclopentadienyl) ruthenium derivative, in which bis (cyclopentadienyl) ruthenium is first made monoanionized or dianionized with an anionizing agent, and then reacted with an electrophilic agent. It is preferable to use the anionizing agent selected from the group consisting of lithium, sodium, potassium, calcium, alkyl lithium, alkyl sodium, alkyl potassium, Grignard reagent and lithium aluminum hydride, and electrophilic agent selected from the group consisting of alkyl, alkenyl and alkynyl halides, aldehydes, and ketones.

### BACKGROUND OF THE INVENTION

1. Field of the Invention

This invention relates to a method of producing bis(cyclopentadienyl) ruthenium derivative. It also relates to a method of forming a thin film of ruthenium or ruthenium compound by chemical vapor deposition using the bis(cyclopentadienyl) ruthenium derivative.

2. Description of the Related Art

Recently, semiconductor devices have been required to have higher and higher functions endlessly. Taking dynamic RAM (DRAM) as an example, it has been developed to have capacity increasing from Mbit size to Gbit size. These movements have been accompanied by rapid developments of the techniques to increase density and extent of integration of semiconductor devices. In order to increase their capacity, attempts have been made to improve not only their structures but also the materials therefor.

Under these situations, noble metals and their compounds have been attracting attention as the materials for thin-film electrodes for semiconductor devices, in particular ruthenium and its compounds, because of their low specific resistance and excellent electrical characteristics they can exhibit when used for electrodes. As such, they are expected to become one category of the central materials for the future thin-film electrodes. In DRAM, in particular, their application to storage batteries for capacitors is being studied as one of the prospective areas they can go into, and they are expected to greatly increase density of these devices.

Chemical vapor deposition (hereinafter referred to as CVD) is normally used to produce a thin film of ruthenium or its compound, because it can easily give a uniform thin film and shows good step coverage capacity. It is expected to become one of the central techniques for the future thin-film electrode production processes, because it can cope with the requirements for further densification of the recent circuits and electronic device members.

Bis(cyclopentadienyl)ruthenium (commonly referred to as ruthenocene), represented by the following formula (1), has been used as the stock material for production of thin films of ruthenium or its compound by CVD. However, bis(cyclopentadienyl)ruthenium has a relatively high melting point, requiring a large quantity of energy for its evaporation, and development of organoruthenium compounds of a lower melting point has been demanded to improve energy efficiency.

Formula (1)

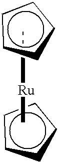

The promising organoruthenium compounds under consideration as the stock materials for CVD are bis(cyclopentadienyl)ruthenium derivatives, which are bis(cyclopentadienyl)ruthenium substituted with a functional group, e.g., alkyl group, in one or both of its cyclopentadiene rings (bis(cyclopentadienyl)ruthenium substituted with a functional group in one or both of its cyclopentadiene rings is referred to as bis(cyclopentadienyl)ruthenium derivatives).

Various methods are known for producing bis (cyclopentadienyl) ruthenium derivatives, and many use an alkyl cyclopentadiene, represented by the formula (2), as the stock material:

Formula (2)

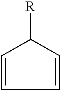

(In the above general structure, R as a substituent is a straight-chain or branched alkyl group.)

For example, Japanese Patent Laid-Open No. 11-35589 discloses a method of producing a bis(alkyl cyclopentadienyl)ruthenium derivative, which is, e.g., a bis(ethyl cyclopentadienyl)ruthenium which is substituted with the alkyl group in both of its cyclopentadiene rings. This method reacts an alkyl cyclopentadiene with ruthenium chloride, represented by the formula (3), and zinc powder in an alcohol solvent:

Formula (3)

R u C I 3

However, the conventional method of producing a bis(cyclopentadienyl)ruthenium derivative from an alkyl cyclopentadiene as the stock material has the problem that it needs a complex process involving a number of steps. Because, production of a high-purity bis(cyclopentadienyl)ruthenium naturally needs the high-purity stock material, and production of high-purity alkyl cyclopentadiene invariably depends on cracking of bisalkyl cyclopentadiene as its polymer, the production process thereof is also complex: it involves cracking of biscyclopentadiene into cyclopentadiene as the monomer, halogenation of the monomer, and polymerization of the halogenated cyclopentadiene into bis(halogenated)cyclopentadiene, and alkylation of the polymer.

A series of the reaction steps for producing bis(alkyl cyclopentadienyl)ruthenium can be summarized by the following formula. As shown, the conventional bis(alkyl cyclopentadienyl)ruthenium production process involves a total of 6 steps. The complex process involving such a number of steps conceivably increases the cost of bis(alkyl cyclopentadienyl)ruthenium production and hinders its massive production.

Formula 4

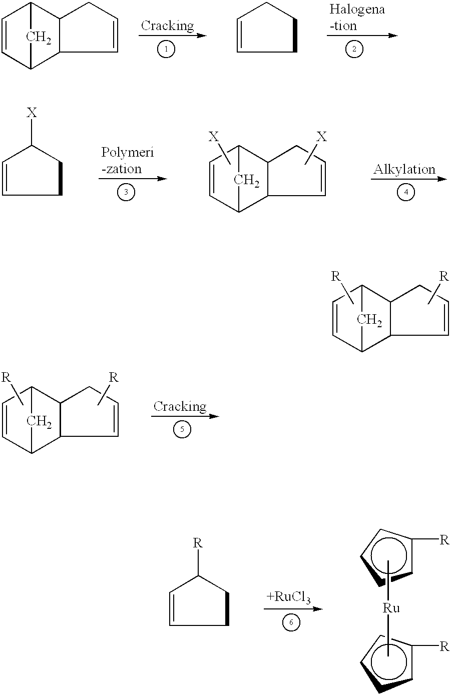

As described earlier, production of high-purity alkyl cyclopentadiene invariably depends on cracking of bisalkyl cyclopentadiene as its polymer, and the cracking step itself involves difficulties; it needs complex procedure for controlling the reactions, because the cracking may produce alkyl cyclopentadienes of different number of alkyl groups.

The above-described problem relates to bis(alkyl cyclopentadienyl)ruthenium among bis(cyclopentadienyl) ruthenium derivative. However, such a problem is anticipated to occur when a functional group other than an alkyl group is to be introduced, or a functional group is to be introduced into one of the cyclopentadiene rings of bis(cyclopentadienyl)ruthenium.

The present invention is developed to solve the above problems involved in the conventional process. It is an object of the present invention to provide a method of producing a bis (alkyl cyclopentadienyl) ruthenium derivative having a reduced number of production steps, reducing the production cost and giving a high-purity product.

### SUMMARY OF THE INVENTION

The inventors have found, after having studied to solve the above problems, that it is adequate to directly introduce a target functional group into bis(cyclopentadienyl)ruthenium as the stock material, in order to efficiently produce its derivative, and, at the same time, it is necessary to develop an efficient procedure for directly introducing a functional group into bis(cyclopentadienyl)ruthenium. They have extensively studied to find such a procedure, to develop the method in which the stock material is first dianionized to be an intermediate and the intermediate is then reacted with a given compound, reaching the present invention.

The present invention provides a method of producing a bis(cyclopentadienyl)ruthenium derivative, in which bis(cyclopentadienyl)ruthenium is first monoanionized or dianionized with an anionizing agent, and then reacted with an electrophilic agent.

The method of producing bis (cyclopentadienyl) ruthenium as the stock material for the present invention is not limited. To cite some of the examples; (1) cyclopentadiene and a ruthenium halide (e.g., RuCl₃) are reacted with zinc powder in an alcohol solvent, (2) cyclopentadiene is reacted with a ruthenium halide in the presence of a base, and (3) cyclopentadiene is reacted with a ruthenium carbonyl (Ru(CO)ₙ) under heating at 250 to 300° C. Cyclopentadiene for these processes can be easily produced by, e.g., cracking of biscyclopentadiene.

The applicable anionizing agents for anionizing bis(cyclopentadienyl)ruthenium include lithium, sodium, potassium, calcium, alkyl lithium, alkyl sodium, alkyl potassium, Grignard reagent and lithium aluminum hydride.

The electrophilic agent for transforming dianionic bis(cyclopentadienyl)ruthenium into a bis(cyclopentadienyl)ruthenium derivative is selected from the compounds having a functional group corresponding to the target functional group (alkyl, alkenyl, alkynyl or the like). The suitable electrophilic agents for the present invention include halides (e.g., alkyl, alkenyl and alkynyl halides), aldehydes and ketones. Alkyl halides, e.g., methyl, ethyl, n-propyl, iso-propyl, n-butyl, iso-butyl, sec-butyl and tert-butyl halides, are suitable electrophilic agents particularly for production of the alkyl derivatves, e.g., bis(alkyl cyclopentadienyl)ruthenium and alkyl cyclopentadienyl(cyclopentadienyl)ruthenium.

The reactions for dianionizing bis(cyclopentadienyl)ruthenium and those proceeding in the presence of an electrophilic agent are preferably effected in an adequate solvent. The solvent should dissolve bis (cyclopentadienyl) ruthenium, an anionizing agent and an electrophilic agent, and, at the same time, not be reactive with bis (cyclopentadienyl) ruthenium. These solvents include tetrahydrofuran and toluene.

Reaction temperature for production of the bis(cyclopentadienyl)ruthenium derivative of the present invention is preferably in a range from −80 to 0° C. At below −80° C., the reaction proceeds too slowly. At above 0° C., on the other hand, side-reactions (multi-addition reactions) occur to decrease purity of the target bis(cyclopentadienyl)ruthenium derivative.

Whether bis(cyclopentadienyl)ruthenium is monoanionized or dianionized for the present invention, i.e., whether it is substituted with a functional group in one or both cyclopentadienyl rings, can be controlled by the reaction ratio of bis(cyclopentadienyl)ruthenium to the anionizing agent. More concretely, it is preferable that the bis(cyclopentadienyl)ruthenium/anionizing agent reaction (molar) ratio is set at 1 when it is to be made monoanionic, and at 0.5 when it is to be made dianionic.

The method of the present invention can convert bis(cyclopentadienyl)ruthenium into its derivative in two steps. The following formula (5) represents the reactions for producing bis(cyclopentadienyl)ruthenium derivatives, to which the above-described method of producing bis(cyclopentadienyl)ruthenium is applied. As shown, the method of the present invention involves 4 steps, including those for producing bis (cyclopentadienyl) ruthenium, and can produce the bis (cyclopentadienyl) ruthenium derivative using a reduced number of steps than the conventional method. Therefore, the method of the present invention can reduce the production cost for the bis(cyclopentadienyl)ruthenium derivative, and, at the same time, sufficiently cope with its mass production.

Formula (5)

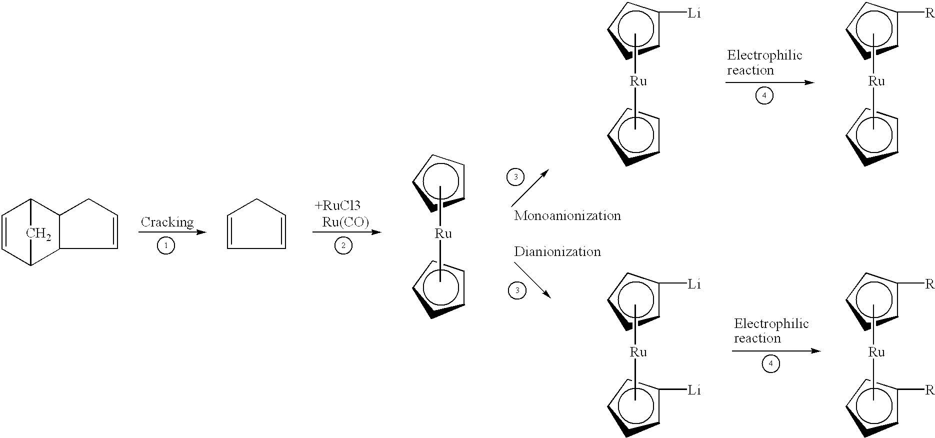

The reduced step number also decreases the possibility of contamination with impurities. Therefore, the present invention can give the bis(cyclopentadienyl)ruthenium derivative of higher purity. The bis(cyclopentadienyl)ruthenium derivative produced by the method of the present invention is suitable as the stock material for production of thin films by CVD, and the CVD-based thin-film production method with the bis(cyclopentadienyl)ruthenium derivative as the stock material can give the thin film of ruthenium or ruthenium compound which satisfies the required purity, electrical characteristics and morphology for the electrode material.

### DETAILED DESCRIPTION OF THE PREFERRED EMBODIMENTS

The preferred embodiments of the present invention will be described below. In the embodiments, bis(ethyl cyclopentadienyl)ruthenium and butyl cyclopentadienyl(cyclopentadienyl)ruthenium were prepared as the bis(cyclopentadienyl)ruthenium derivatives, to confirm their purity, and made into the thin films to analyze their properties.

First Embodiment: 5.0 mL of a hexane solution of n-butyl lithium (concentration: 2.6 mol/L), put in a nitrogen-purged flask, was cooled to −78° C., to which 1.74g of bis (cyclopentadienyl) ruthenium was added, and then 50 mL of tetrahydrofuran was added dropwise over 1 hour for the reactions. The reaction solution was left for 2 hours to bring it back to room temperature, to allow the reactants to react with each other for 24 hours.

The reaction solution was cooled to −78° C. again, to which 9.81g of ethyl bromide was added dropwise over 1 hour for the reactions, and left for 2 hours to bring it back to room temperature, at which the reactants were allowed to react with each other for 24 hours.

On completion of the reactions, 100 mL of water was added to the reaction solution, from which bis(ethylcyclopentadienyl)ruthenium was solvent-extracted with hexane. The extract was then treated to distill off hexane, to obtain 2.0g of bis(ethylcyclopentadienyl)ruthenium, in a yield of 90%.

This bis (ethylcyclopentadienyl) ruthenium was analyzed by gas chromatography. Many of the peaks in the profile were relevant to bis(ethylcyclopentadienyl)ruthenium, and peaks relevant to impurities were rarely observed. Therefore, it was confirmed that the bis(ethylcyclopentadienyl)ruthenium had a very high purity of 99%.

The bis(ethylcyclopentadienyl)ruthenium prepared in this embodiment was made into a thin film of ruthenium by CVD under the following reaction conditions: Substrate temperature: 300° C. Chamber pressure: 700 Pa (5 torr) Carrier gas: Argon/oxygen Flow rate of the carrier gas: 200/200 sccm

The surface of the thin ruthenium film thus prepared was analyzed by an atomic force microscope (AFM) to observe its morphology and roughness. As a result, it was confirmed that the thin film had a very good average surface roughness (Rms) of 1.5 nm and also had good morphology.

Second Embodiment: 1.0 mL of a hexane solution of n-butyl lithium (concentration: 2.6 mol/L), put in a nitrogen-purged flask, was cooled to −78° C., to which 1.74g of bis(cyclopentadienyl)ruthenium was added, and then 50 mL of tetrahydrofuran was added dropwise in 1 hour for the reactions, as was the case with First Embodiment. The reactants were allowed to react with each other at room temperature for 24 hours. The reaction solution was cooled to −78° C., to which 9.81g of butyl bromide was added dropwise, and the reactants were allowed to react with each other for 24 hours.

On completion of the reactions, butyl cyclopentadienyl(cyclopentadienyl)ruthenium was solvent-extracted with hexane from the reaction solution. The extract was then treated to distill off hexane, to obtain 1.94g of butyl cyclopentadienyl (cyclopentadienyl) ruthenium, in a yield of 89.8%.

This butylcyclopentadienyl(cyclopentadienyl)ruthenium was 99% pure, as observed with the use of gas chromatography.

The butylcyclopentadienyl(cyclopentadienyl)ruthenium was made into a thin film of ruthenium under the conditions similar to those for First Embodiment. The surface of the thin ruthenium film thus prepared was analyzed by an AFM to observe its morphology and roughness. As a result, it was confirmed that the thin film had a very good average surface roughness (Rₘₛ) of 0.8 nm and also had good morphology.

Comparative Example: Bis(ethylcyclopentadienyl)ruthenium was prepared by the conventional method, to compare its purity with that of the bis(ethylcyclopentadienyl)ruthenium prepared in First Embodiment.

First, 800g of bisethylcyclopentadiene, put in a reactor, was cracked under heating at 200° C. in a hot bath into ethylcyclopentadiene.

Then, 25.0g of ruthenium chloride trihydrate was dissolved in 200 mL of ethyl alcohol as the alcohol solvent in anitrogen-purgedflask, and the mixture was cooled to −30° C., to which 40g of the ethylcyclopentadiene prepared above was added. 9.55g of zinc powder, divided into 7 parts, was added one by one to the above solution kept at −25 to −10° C. with stirring, for the reactions.

Then, bis(ethylcyclopentadienyl)ruthenium was solvent-extracted with hexane from the reaction solution. The extract was then treated to distill off hexane, to obtain 19.7g of bis(ethylcyclopentadienyl)ruthenium.

This bis (ethylcyclopentadienyl)ruthenium was 94% pure, as observed with the use of gas chromatography.

What is claimed is:

1. A method of producing a bis (cyclopentadienyl) ruthenium derivative, wherein bis(cyclopentadienyl) ruthenium is first made monoanionized or dianionized with an anionizing agent, and then reacted with an electrophilic agent.

2. The method of producing a bis(cyclopentadienyl) ruthenium derivative according to claim 1, wherein said anionizing agent is selected from the group consisting of lithium, sodium, potassium, calcium, alkyl lithium, alkyl sodium, alkyl potassium, Grignard reagent and lithium aluminum hydride.

3. The method of producing a bis(cyclopentadienyl) ruthenium derivative according to claim 1 or 2, wherein said electrophilic agent is selected from the group consisting of alkyl, alkenyl and alkynyl halides, aldehydes, and ketones.

4. The method of producing a bis(cyclopentadienyl) ruthenium derivative according to claim 3, wherein the alkyl group for said alkyl halide is selected from the group consisting of methyl, ethyl, n-propyl, iso-propyl, n-butyl, iso-butyl, sec-butyl and tert-butyl.

5. A bis(cyclopentadienyl) ruthenium derivative produced by the method according to one of claims 1 to 4.

6. A method of producing a thin film of ruthenium or its compound, wherein the bis(cyclopentadienyl) ruthenium derivative according to claim 5 is evaporated and transferred onto a substrate, which is heated to deposit ruthenium thereon.
